(19) United States
(12) Patent Application Publication
(10) Pub. No.: US 2008/0251255 A1
(43) Pub. Date: Oct. 16, 2008

(54) STEAM INJECTION APPARATUS FOR STEAM ASSISTED GRAVITY DRAINAGE TECHNIQUES

(75) Inventors: Kevin J. Forbes, Houston, TX (US); Nihat Ovutmen, Sugar Land, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/778,233

(22) Filed: Jul. 16, 2007

Related U.S. Application Data
(60) Provisional application No. 60/911,156, filed on Apr. 11, 2007.

(51) Int. Cl. E21B 43/16; B05B 1/14

(52) U.S. Cl. 166/305.1; 166/222; 239/551

(57) ABSTRACT

Steam injection pipe string apparatus is disclosed comprising an elongated tubular structure with first and second ends, and a plurality of orifices formed in the elongated tubular structure. The sizes of the orifices vary from one end of the elongated tubular structure to the other, and, in one embodiment, the sizes of the orifices increase from one end of the elongated tubular structure to the other. The elongated tubular structure may comprise a plurality of blank pipes in threaded engagement with one another or a plurality of subs with different sized orifices in the subs. The orifices may be formed in the elongated tubular structure using milling techniques or by inserting a nozzle in a threaded aperture formed in the structure. A system utilizing the steam injection pipe string apparatus is especially suitable for use in a steam assisted gravity drainage system.

### CROSS-REFERENCE TO RELATED APPLICATION

This application claims the benefit of U.S. Provisional Patent Application No. 60/911,156, filed Apr. 11, 2007.

### BACKGROUND

1. Field of the Invention

This invention relates generally to oil recovery methods using steam assisted gravity drainage (SAGD) technology.

2. Description of the Prior Art

In many areas of the world, large deposits of viscous petroleum exist, and these deposits are often referred to as “tar sand” or heavy oil” deposits due to the high viscosity of the hydrocarbons which they contain. These tar sands may extend for many miles and occur in varying thicknesses of up to more then 300 feet. Although tar sand deposits may lie at or near the earth's surface, generally they are located under a substantial overburden which may be as great as several thousand feet thick. Tar sands located at these depths constitute some of the world's largest presently known petroleum deposits. The tar sands contain a viscous hydrocarbon material, commonly referred to as a bitumen, in an amount which typically ranges from about 5 to about 20 percent by weight. While bitumen is usually immobile at typical reservoir temperatures, the bitumen generally becomes mobile at higher temperatures and has a substantially lower viscosity at higher temperature than at the lower temperatures.

Since most tar sand deposits are too deep to be mined economically, a serious need exists for an in situ recovery process wherein the bitumen is separated from the sand in the formation and produced through a well drilled into the deposit. Two basic technical requirements must be met by any in situ recovery process: (1) the viscosity of the bitumen must be sufficiently reduced so that the bitumen will flow to a production well; and (2) a sufficient driving force must be applied to the mobilized bitumen to induce production.

Hydrocarbon recovery may be enhanced in certain heavy oil and bitumen reservoirs by using SAGD. When using SAGD, horizontal production and steam injection wellbores are drilled into the hydrocarbon reservoir formations and steam is injected into the steam injection wellbore. The production and steam injection wellbores relatively are closely spaced in the vertical direction, and the injection of steam into the steam injection wellbore causes the heavy hydrocarbons in the production wellbore to become mobile due to the reduction of in situ viscosity. The benefits of SAGD over conventional secondary thermal recovery techniques include higher oil productivity relative to the number of wells employed and higher ultimate recovery of oil in place.

U.S. Pat. No. 6,988,549 discusses certain problems associated with typical SAGD projects. According to the '549 patent: (a) the economics of such projects is significantly impacted by the cost associated with generating steam; (b) SAGD does not typically employ the use of super-saturated steam because of the high cost of producing this steam with conventional hydrocarbon-fired tube boilers which results in using steam that is less efficient in transferring heat to the heavy oil reservoir; and (c) the produced water associated hydrocarbon production from these operations is typically disposed of in a commercially operated disposal well for a fee.

It is believed that the economics of SAGD may have been adversely impacted by the mechanisms heretofore utilized to inject steam and that the economics may be substantially increased by providing a homogeneous distribution of steam in the steam injection wellbore. This novel and useful for result is achieved with the apparatus of the present invention.

### SUMMARY OF THE INVENTION

In accordance with the present invention, steam injection pipe string apparatus is provided for use in the steam injection wellbore in a SAGD operation. A steam injection pipe string according to the present invention comprises an elongated tubular structure having first and second ends which is inserted into the steam injection wellbore and which is utilized to provide steam to that wellbore. Steam injection pipe string apparatus according to the present invention comprises a plurality of orifices, e.g. nozzles, which are disposed in and along the length of the elongated tubular structure. The sizes of the nozzles vary between the first and second ends of the elongated tubular structure, and, in one embodiment, the sizes of the nozzles increase between the first and second ends of the elongated tubular structure. The orifices in the elongated tubular structure are thus sized to yield equalized pressure/temperature steam injection at each section along the steam injection wellbore.

Steam injection pipe string apparatus according to the present invention may be implemented by using a plurality of blank pipes in threaded engagement with one another. Nozzles may be formed in the blank pipes utilizing milling techniques or by forming threaded apertures in the blank pipe and installing a nozzle in each threaded aperture.

Alternatively, pipe string apparatus according to the present invention may be formed by joining a plurality of subs together. In this latter instance, each sub has a different size nozzle depending upon its location in the steam injection pipe string.

Additionally, steam injection pipe string apparatus according to the present invention may be implemented using sand-screen sections where the nozzle is arranged to direct the injected steam choked flow parallel to the wellbore. By using such sand screen apparatus, the flow of steam dissipates somewhat upon exiting the steam injection pipe string so as not to erode the wellbore. In another words, the use of a sand-screen apparatus to inject the steam into the steam injection wellbore lessens erosion of that wellbore.

In accordance with the present invention, a system is provided for injecting steam into a wellbore. The system comprises a source of steam and a steam injection pipe string. The steam injection pipe string comprises an elongated tubular structure with first and second ends, where the first end is operatively coupled to the source of steam and where the steam injection pipe string comprises a plurality of orifices which increase in size from the first to the second end of the tubular structure. The elongated tubular structure may comprise a plurality of blank pipes in threaded engagement with one another or a plurality of subs in threaded engagement with one another with different sized orifices in each of the subs. The orifices may, for example, comprise nozzles which may either be formed in the elongated tubular member using milling techniques or which may be installed in threaded apertures formed in the elongated tubular member. The orifices may also comprise sand screen apparatus.

In accordance with the present invention, a steam assisted gravity drainage system is provided comprising a horizontal production wellbore and a horizontal steam injection wellbore which is vertically spaced from and in proximity to the production wellbore. A source of steam is provided which is connected to one end of a steam injection pipe composed of an elongated tubular structure and a plurality of orifices in that structure. The orifices increase in size as the distance from the end of the tubular structure connected to the steam increases.

### BRIEF DESCRIPTION OF THE DRAWINGS

In the accompanying drawings:

FIG. 1 is an elevation view in partial cross-section illustrating a production wellbore and a steam injection wellbore containing one embodiment of apparatus in accordance with the present invention.

FIG. 2 is an elevational drawing in cross-section of the injection and production wellbores in FIG. 1.

FIG. 3 is a cross-sectional of a steam injection wellbore containing steam injection pipe string apparatus implemented using sand screen apparatus.

FIGS. 4 and 5 are cross-sectional drawings illustrating alternative configurations for an inflow control device.

FIG. 6 is a perspective view in partial cross-section of another embodiment of steam injection pipe string apparatus implemented using a plurality of subs.

FIG. 7 is an elevation view in partial cross-section of one embodiment of a metal-to-metal seal that may be utilized in the inflow control devices of FIGS. 4 and 5.

FIG. 8 is an elevation view in partial cross-section of one embodiment of a combination of an inflow control device and sand screen apparatus that may be utilized by the present invention.

### DESCRIPTION OF SPECIFIC EMBODIMENTS

It will be appreciated that the present invention may take many forms and embodiments. In the following description, some embodiments of the invention are described and numerous details are set forth to provide an understanding of the present invention. Those skilled in the art will appreciate, however, that the present invention practiced without those details and that numerous variations from and modifications of the described embodiments may be possible. The following description is thus intended to illustrate and not limit the present invention.

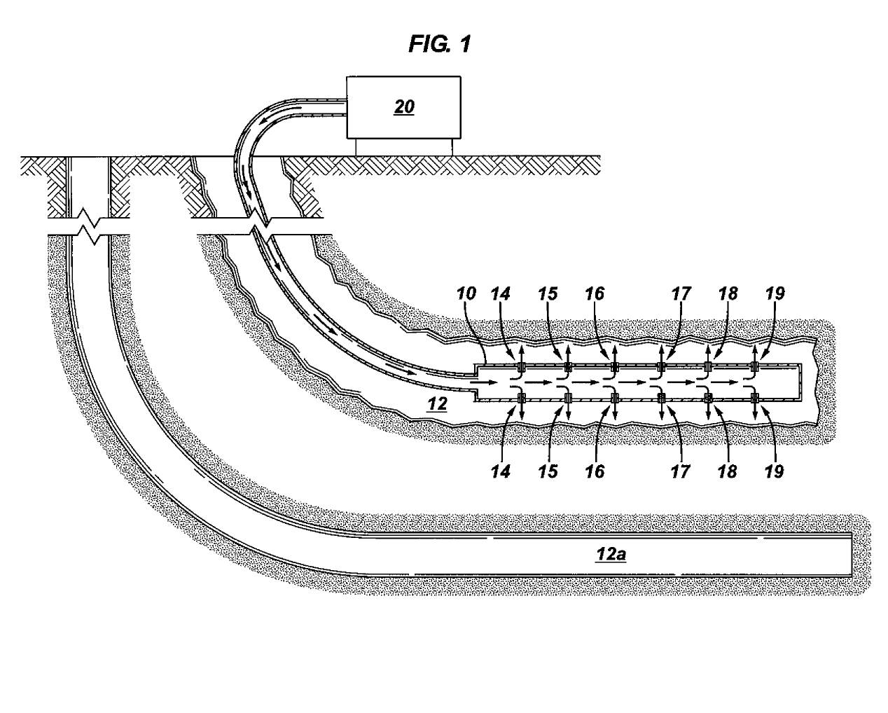

With reference first to FIG. 1, there is illustrated a system comprising a source of steam 20 located at the earth's surface. The source of steam 20 is coupled to one end of steam injection pipe string apparatus 10 in accordance with the present invention. Steam injection pipe string apparatus 10, as illustrated, is an elongated tubular structure and is located in steam injection wellbore 12. In SAGD operations, steam injection wellbore 12 is typically not cased and is closely spaced in the vertical direction from a production wellbore 12a.

Steam injection pipe string 10 comprises a plurality of orifices 14-19 which are disposed at spaced intervals along the length of steam injection pipe string 10. Orifices 14 are the closest orifices in steam injection pipe string 10 to the source of steam 20, while orifices 19 are the orifices which are furthest away from source of steam 20.

In accordance with the present invention, orifices 14-19 are sized in steam injection pipe string 10 to yield equalized pressure/temperature steam injection along the length of steam injection wellbore 12. Accordingly, the size of the orifices in steam injection pipe string 10 increases as the distance of the orifice from the source of steam 20 increases. In the exemplary embodiment illustrated in FIG. 1, orifices 14 would be the smallest orifices in size in the steam injection pipe apparatus 10 and the sizes of orifices 15-19 would increase with the size of orifices 19 being the largest in the exemplary embodiment illustrated in FIG. 1.

In some circumstances, the sizes of the orifices 14-19 may vary across the length of steam injection pipe string 10 based on wellbore parameters, e.g., permeability of the zones of interest. Further, the nozzles 14-19 in steam injection pipe string 10 may have variable orifices, where the openings in such orifices may be varied from a control line (not shown) or based on the temperature in steam injection pipe string 10. For example, the opening in a variable orifice may constrict or choke more under higher temperatures than at lower temperatures.

Steam injection pipe apparatus according to the present invention may be implemented in a number of ways. Still referring to FIG. 1, a steam injection pipe string apparatus 10 may be implemented using a plurality of blank pipes which are connected in threaded engagement and which have orifices formed therein according to the orifice sizing criteria discussed above. The orifices may comprise nozzles and may be formed in the blank pipe utilizing standard and well-known milling techniques. Alternatively, threaded apertures may be formed in the blank pipe and a nozzle may be installed in each threaded aperture.

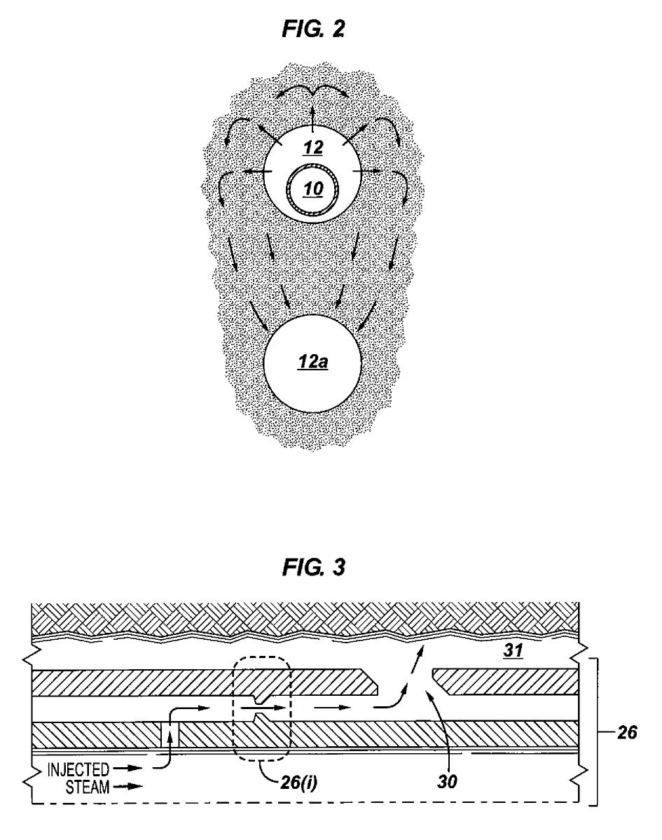

With reference to both FIGS. 1 and 2, steam injection pipe string apparatus 10 may be disposed in injection wellbore 12 such that the steam is not directed to the portion of the earth's crust between injection wellbore 12 and production wellbore 12a. Rather, steam injection pipe string apparatus 10 is disposed in injection wellbore 12 such that the injected steam is directed toward the top of injection wellbore 12, as illustrated in FIG. 2. Directing the injected steam in the manner illustrated in FIG. 2 assists in preventing erosion of that portion of the earth's crust between the two wellbores.

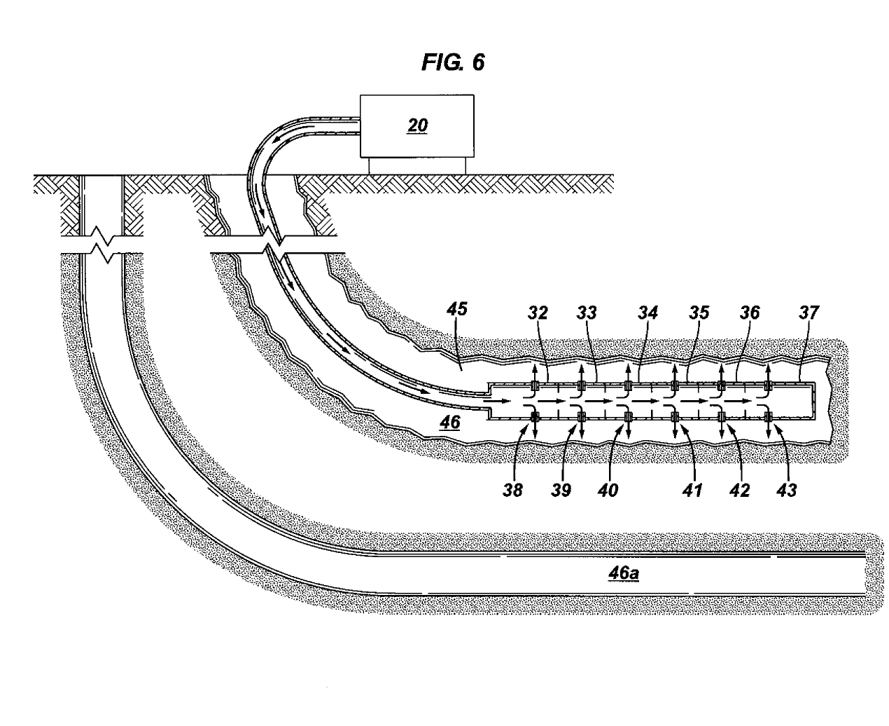

With reference now to FIG. 6, a system comprising a source of steam 20 and a steam injection pipe string apparatus 45 is illustrated. Steam injection pipe apparatus 45 is disposed in steam injection wellbore 46 which is closely spaced in the vertical direction from production wellbore 46a. Steam injection pipe apparatus 45 comprises a plurality of subs 32-37 where each sub has a different size orifice from the other subs in apparatus 45. For example, sub 32 comprises orifices 38 which are the smallest orifices in steam injection pipe string 45. The orifices 39-43 in subs 33-37, respectively, increase in size and according to the orifice sizing criteria discussed above. The subs 32-37 may, for example, be coupled together using threaded connections (not shown).

With reference to FIG. 3, steam injection pipe apparatus 10 of FIG. 1 may be implemented using sand-screen apparatus comprising a plurality of sections 26, where each section 26 contains a plurality of orifices 26(i), and where the orifices are sized as discussed above. In the section of sand-screen apparatus illustrated in FIG. 2, orifice 26(i) comprises a nozzle which is arranged to direct the flow of steam out of the sand screen apparatus in a direction parallel to the wellbore. In the arrangement of FIG. 2, the flow of steam dissipates somewhat upon exiting the steam injection pipe string at opening 30 so as not to erode the sides of wellbore 31. Once type of sand screen apparatus which is believed to be especially appropriate for use in a steam injection pipe string is the inflow flow control device described in U.S. Patent Application Publication No. US 2006/0048942, which is incorporated herein by reference.

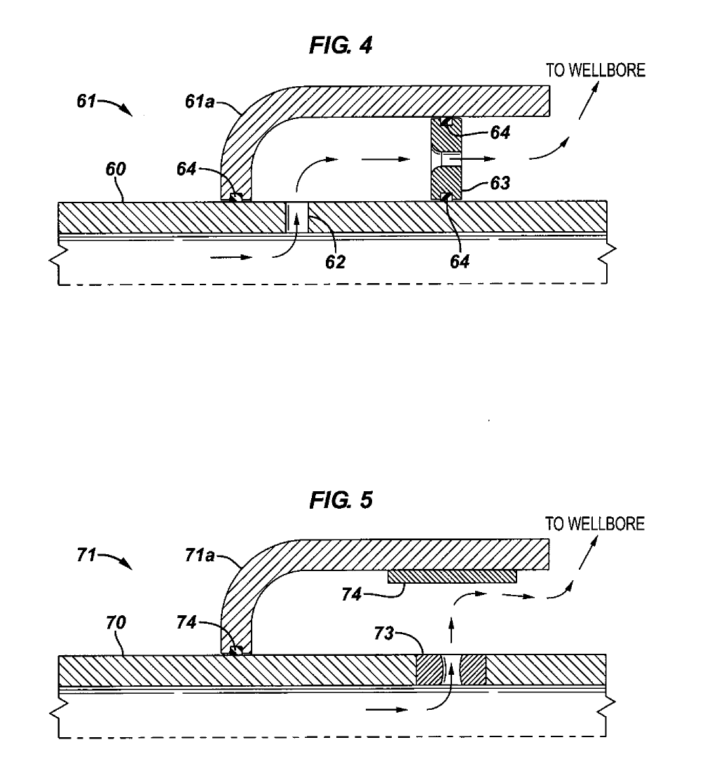

Referring to FIGS. 4 and 5, alternative configurations of inflow control devices are illustrated. In FIG. 4, inflow control device 61, which includes housing 61a, is formed on tubing 60, which is resident in steam injection pipe string apparatus according to the present invention. Steam may be directed through opening 62 in tubular member 60 and then through orifice 63 and into the injection wellbore. Orifice 63 may, for example, comprise a nozzle.

In FIG. 5, the inflow control device 71 is formed on tubing 70 and comprises housing 71a. Orifice 73, which may also comprise a nozzle is installed in an aperture formed in tubing 70 as illustrated. Protection layer 74 is applied to the bottom of housing 71a to prevent the steam from directly contacting the housing 71a of inflow control device 71. Protective layer 74 may, for example, comprise a ceramic or a tungsten carbide coating which covers all or part of the portion of the housing 71a of inflow control device 71, which would be exposed to the steam.

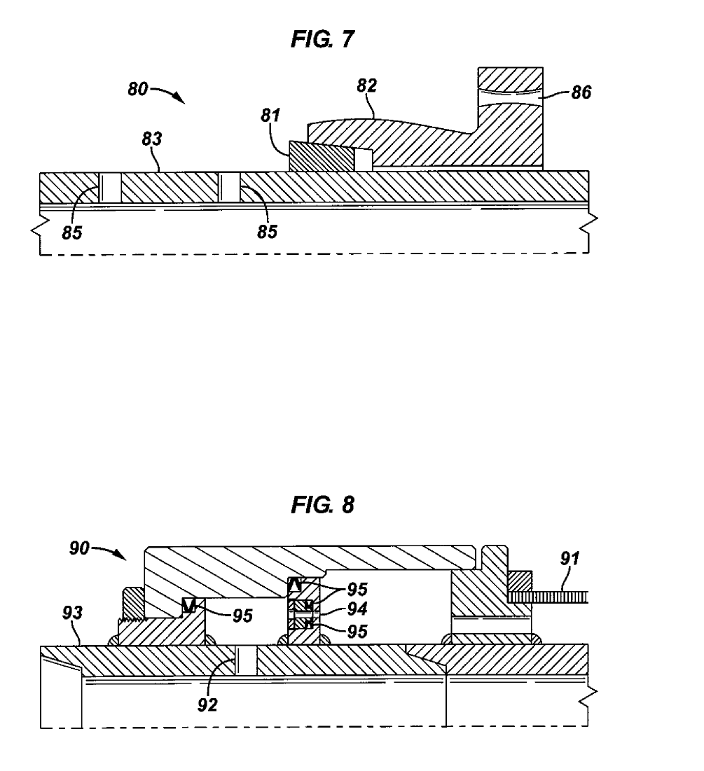

The inflow control devices illustrated in FIGS. 4 and 5 employ seals which are represented schematically by reference designators 64 and 74. With reference now to FIG. 7, there is illustrated a metal-to-metal embodiment of such seals. In FIG. 7, seal 80 comprises ring 81 which is forced against ring 82 containing nozzle 86. This results in a shrink fit seal 84 toward the base pipe 83. Openings 85 are formed in base pipe 83 to permit the flow of steam from the base pipe through nozzle 86 and into a steam injection wellbore.

Referring now to FIG. 8, there is illustrated inflow control device 90 which is utilized with sand screen apparatus 91. An opening 92 is formed in base pipe 93 to permit the flow of steam through nozzle 94 and into the steam injection wellbore via sand screen apparatus 91. The inflow control device 90 in FIG. 8 utilizes a plurality of C-type metal seals 95.

In accordance with the present invention, steam injection pipe string apparatus according to the present invention may further comprise Distributed Temperature Sensing (DST) apparatus, such as is available from the assignee of the present application. Such DST apparatus advantageously utilizes fiber optic cables containing sensors to sense the temperature changes along the length of the injection apparatus and may, for example, provide information from which a temperature profile for the well may be prepared.

The foregoing description has focused on utilization of inflow control devices in the steam injection wellbore in SAGD operations. Those skilled in the art will appreciate that inflow control devices may also be utilized in the production wellbore.

What is claimed is:

1. Steam injection pipe string apparatus, comprising:
an elongated tubular structure having first and second ends; and
a plurality of orifices formed in the elongated tubular structure, where the sizes of the orifices vary between the first and second ends of the elongated tubular structure.

2. The steam injection pipe apparatus of claim 1, wherein the sizes of the orifices increase between the first and second ends of the elongated tubular structure.

3. The steam injection pipe string apparatus of claim 1, wherein the elongated tubular structure comprises a plurality of blank pipes in threaded engagement with one another and with orifices formed therein.

4. The steam injection pipe string apparatus of claim 3, wherein the orifices comprise nozzles.

5. The steam injection pipe string apparatus of claim 4, wherein the nozzles are formed in the elongated tubular structure utilizing milling techniques.

6. The steam injection pipe string apparatus of claim 4, wherein it comprises a plurality of threaded apertures formed in the elongated tubular structure and a nozzle which is installed in each threaded aperture.

7. The steam injection pipe string apparatus of claim 6, wherein the orifices comprise flow control devices.

8. The steam injection pipe string apparatus of claim 1, wherein the elongated tubular structure comprises a plurality of subs with different sized orifices in said subs.

9. The steam injection pipe string apparatus of claim 8, wherein the orifices are nozzles.

10. The steam injection pipe string apparatus of claim 9, wherein the nozzles are formed in the elongated tubular structure utilizing milling techniques.

11. The steam injection pipe string apparatus of claim 9, wherein it comprises a plurality of threaded apertures formed therein and a nozzle is installed in each threaded aperture.

12. The steam injecting pipe string apparatus of claim 11, wherein the orifices comprise flow control devices.

13. A system for injecting steam into a wellbore, comprising:
a source of steam; and
a steam injection pipe string comprising an elongated tubular structure with first and second ends, where the first end is operatively coupled to the source of steam and where the steam injection pipe string comprises a plurality of orifices which vary in size between the first and second ends of the elongated tubular structure.

14. The system of claim 13, wherein the sizes of the orifices increase between the first and second ends of the elongated tubular structure.

15. The system of claim 13, wherein the elongated tubular structure comprises a plurality of blank pipes in threaded engagement with one another and with orifices formed therein.

16. The system of claim 15, wherein the orifices comprise nozzles.

17. The system of claim 16, wherein the nozzles are formed in the elongated tubular structure utilizing milling techniques.

18. The system of claim 16, wherein the elongated tubular structure comprises a plurality of threaded apertures formed therein and a nozzle which is installed in each threaded aperture.

19. The system of claim 18, wherein the orifices comprise flow control devices.

20. The system of claim 13, wherein the elongated tubular structure comprises a plurality of subs with different sized orifices in said subs.

21. The system of claim 20, wherein the orifices comprise nozzles.

22. The system of claim 21, wherein the nozzles are formed in the elongated tubular structure utilizing milling techniques.

23. The system of claim 21, wherein it comprises a plurality of threaded apertures formed therein and a nozzle is installed in each threaded aperture.

24. (canceled)

25. A steam assisted gravity drainage system comprising,
a horizontal production wellbore;
a horizontal steam injection wellbore which is vertically spaced from and in proximity to the production wellbore;
a source of steam; and
a steam injection wellbore which comprises an elongated tubular structure with first and second ends, where the first end is operatively coupled to the source of steam and where the elongated tubular structure comprises a plurality of orifices which vary in size between the first and second ends of the elongated tubular structure.

26. The system of claim 25, where the sizes of the orifices in the elongated tubular structure increase between its first and second ends.
